(19) United States
(12) Patent Application Publication
(10) Pub. No.: US 2026/0043296 A1
(43) Pub. Date: Feb. 12, 2026

(54) ENHANCED SECURITY SELF-STORAGE DOOR

(71) Applicant: JANUS INTERNATIONAL GROUP, LLC, Temple, GA (US)

(72) Inventors: Curtis Leon SCHROEDER, Carrollton, GA (US); John Morgan HODGES, Sarasota, FL (US); Norman Victor M. NETTIE, Kennesaw, GA (US)

(21) Appl. No.: 19/272,798

(22) Filed: Jul. 17, 2025

Related U.S. Application Data
(60) Provisional application No. 63/680,309, filed on Aug. 7, 2024.

(51) Int. Cl. E06B 9/17; E06B 9/15

(52) U.S. Cl. CPC E06B 9/17046; E06B 9/15

(57) ABSTRACT

An enhanced security self-storage door assembly system can includes a self-storage door and self-storage door frame, the self-storage door can include a bottom bar assembly configured to block against disengagement between the self-storage door and the self-storage door frame.

### CROSS REFERENCE TO RELATED APPLICATION

This utility patent application claims the benefit of priority to U.S. Provisional Application No. 63/680,309, filed Aug. 7, 2024, the content of which is incorporated by reference herein in its entirety.

### TECHNICAL FIELD

The present disclosure generally relates to devices, systems, and methods for access security within a self-storage facility, and more specifically for self-storage door system security.

### BACKGROUND

Self-storage facilities often rent or lease storage space to tenants such as individuals and businesses. A self-storage facility may separate its storage space by unit. While an individual unit can be anything from lockers, containers, to even outdoor spaces, a typical unit often corresponds to an enclosed, possibly climate-controlled, room that is accessible via a lockable self-storage door assembly.

However, security of such self-storage units must be balanced against the costs for increased security. Common brute force attempts to penetrate self-storage units for unauthorized entry can be challenging to avoid, but overdesign can lead to waste.

### SUMMARY

The present application discloses one or more of the features recited in the appended claims and/or the following features which, alone or in any combination, may comprise patentable subject matter.

According to an aspect of the present disclosure, a self-storage door assembly may include a self-storage door frame defining a doorway, the self-storage door frame including a guide assembly including at least one track extending vertically; and a self-storage door for engagement with the self-storage door frame for movement along the guide assembly between a closed position blocking against access through the door way and an open position allowing access through the door way. The self-storage door may include a curtain assembly including a number of panels; and a bottom bar assembly coupled with the curtain assembly near a lower end thereof. The bottom bar assembly may include a reinforcement strut coupled with the curtain assembly to block against deflection of the self-storage door, and at least one guide retention clip coupled with the reinforcement strut and received within the track of the guide assembly to block against movement of the self-storage door out from engagement with the self-storage door frame.

In some embodiments, the at least one guide retention clip and the reinforcement strut may be fastened together by clinch lock. The clinch lock may omit a separate fastener. The clinch lock may include deformation of the material of one of the at least one guide retention clip and the reinforcement strut into the other.

In some embodiments, the reinforcement strut may include a rigid stock formed with L-shaped cross-sectional profile. The reinforcement strut may extend along an entire width of the curtain assembly. The reinforcement strut may extend along an entire width of the curtain assembly exceeding 8 feet. The bottom bar assembly may include an additional reinforcement strut coupled with the reinforcement strut, wherein the additional reinforcement strut extends only partially along the width of the curtain assembly.

In some embodiments, the additional reinforcement strut may be positioned near the center of the reinforcement strut. The reinforcement strut may have a thickness within the range of about 0.072 and about 0.097 inches. The reinforcement strut may have a thickness no greater than about 0.097 inches.

In some embodiments, the curtain assembly may include a latch panel of the number of panels. The latch panel may have one of a latch and latch receiver coupled thereto for engagement with the other of the latch receiver and latch coupled with the self-storage door frame to allow selective engagement of the latch with the latch receiver to block against movement of the self-storage door relative to the self-storage frame between the open and closed positions. The latch panel may include at least one guide retention clip coupled thereto and received within the track of the guide assembly. In some embodiments, no other panel of the number of panels may include any guide retention clip.

In some embodiments, the assembly may further include a handle coupled with the self-storage door off-center. The handle may be coupled with the self-storage door near a lateral side thereof.

According to another aspect of the present disclosure, a self-storage door for engagement with a guide assembly of a door frame for movement between a closed position blocking against access through a doorway and an open position allowing access through the doorway, may include a curtain assembly including a number of panels; and a bottom bar assembly coupled with the curtain assembly near a lower end thereof. The bottom bar assembly may include a reinforcement strut coupled with the curtain assembly to block against deflection of the self-storage door, and at least one guide retention clip coupled with the reinforcement strut and received within a track of the guide assembly to block against movement of the self-storage door out from engagement with the self-storage door frame.

In some embodiments, the at least one guide retention clip and the reinforcement strut may be fastened together by clinch lock. The clinch lock may include deformation of the material of one of the at least one guide retention clip and the reinforcement strut into the other. The reinforcement strut may include a rigid stock formed with L-shaped cross-sectional profile.

According to another aspect of the present disclosure, a method of assembling a self-storage door may include coupling a reinforcement strut with a curtain assembly as a part of a bottom bar assembly; and coupling at least one guide retention clip with the bottom bar assembly for reception within a track of a guide assembly. In some embodiments, coupling the at least one guide retention clip with the bottom bar assembly may include clinch locking the at least one guide retention clip with a reinforcement strut of the bottom bar assembly. In some embodiments, the at least one guide retention clip may define a narrowed vertical profile. The at least one guide retention clip may include wings projecting vertically on opposites sides of a body, wherein each wing defines a lateral end surface. Each end surface may extend beyond a notch defining an extension portion of the wing.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a front (exterior) elevation view of an enhanced security self-storage system including a self-storage door assembly including a self-storage door and self-storage door frame installed within a self-storage facility to regulate access to the self-storage unit, the self-storage door including a curtain assembly and a bottom bar assembly;

FIGS. 2A & B are respectively side and rear (interior) elevation views of the enhanced security self-storage system of FIG. 1;

FIG. 3 is a partially exploded perspective view of a bottom bar assembly of the enhanced security self-storage system of FIGS. 1-2B;

FIG. 4 is a plan view of a section of the self-storage door of the enhanced security self-storage system of FIGS. 1-3, having a portion received within a guide assembly of the self-storage door frame and showing that a guide retention clip is arranged within the guide assembly to block against movement of the self-storage door out from engagement with the self-storage door frame;

FIG. 5 is a partial elevation view of a section of the self-storage door of the enhanced security self-storage system of FIGS. 1-4, showing that the bottom bar assembly includes the guide retention clip clinch locked for coupling attachment with the self-storage door;

FIG. 6 is a side elevation view of a section of the self-storage door of the enhanced security self-storage system of FIGS. 1-5, showing the bottom bar assembly coupled with a curtain assembly of the self-storage door and showing a profile of the guide retention clip;

FIG. 7 is a perspective view of the guide retention clip having received clinch locking to a reinforcement strut by clinch pressing from an overhead press;

FIG. 8 is a perspective view of the guide retention clip having received clinch locking to the support strut by stamping from the overhead press, showing an opposite side of the reinforcement strut illustrating clinch points of the clinch locked connection;

FIG. 9 is a perspective view of another embodiment of a guide retention clip for use with the self-storage system of FIG. 1;

FIG. 10 is a side elevation view of the guide retention clip of FIG. 9, similar to the view of FIG. 6;

FIG. 11 is a rear elevation view of the guide retention clip of FIGS. 9 and 10; and

FIG. 12 is a top elevation view of the guide retention clip of FIGS. 9-11.

### DETAILED DESCRIPTION

For the purposes of promoting an understanding of the principles of the disclosure, reference will now be made to a number of illustrative embodiments illustrated in the drawings and specific language will be used to describe the same.

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

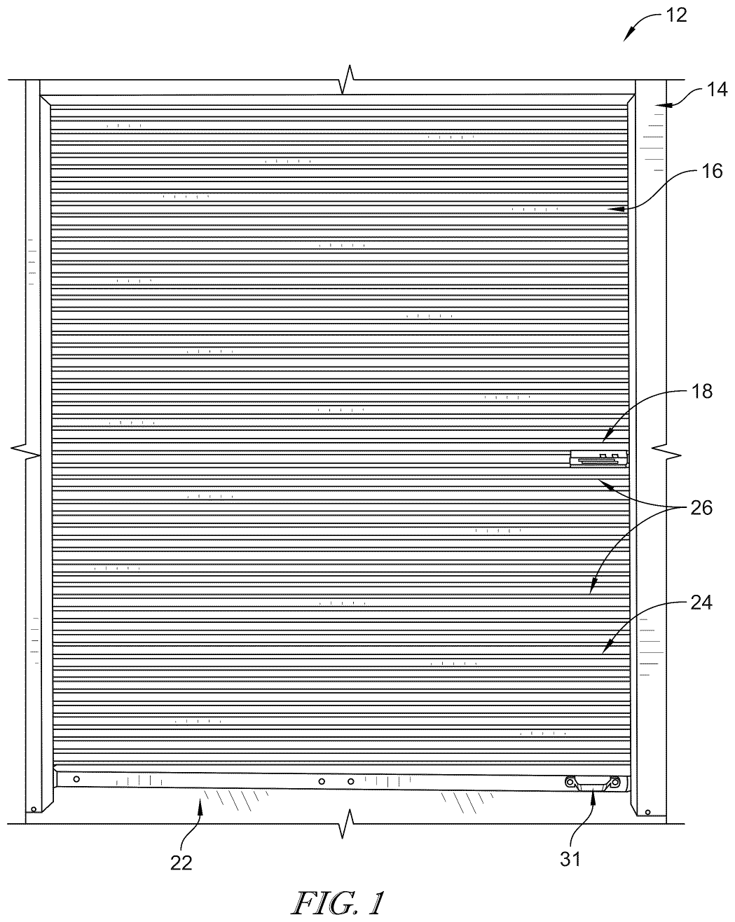

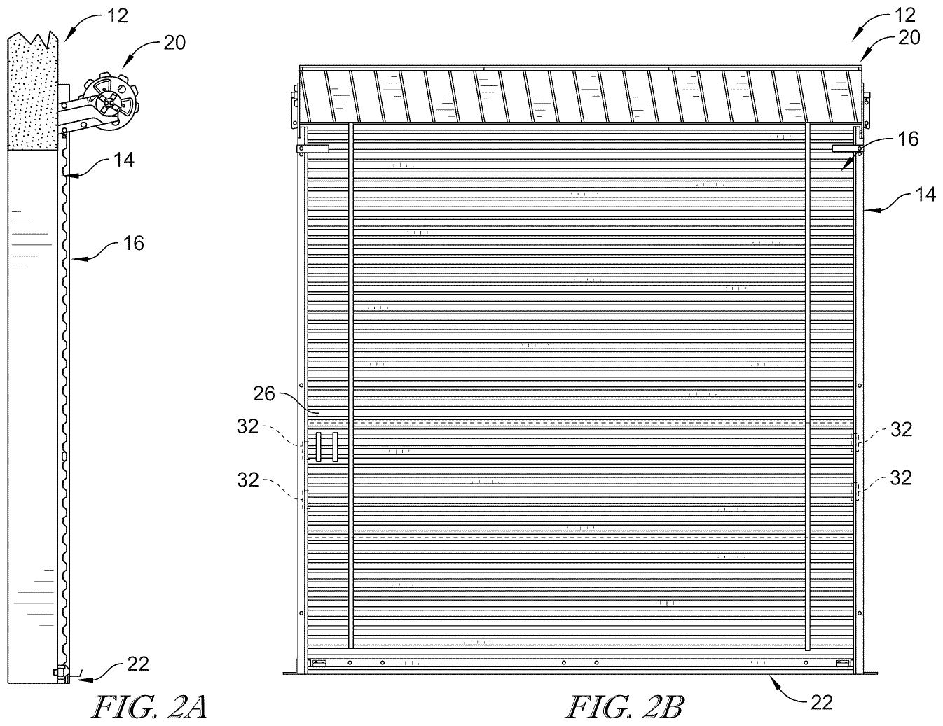

Referring to FIG. 1, a self-storage door system includes a self-storage unit of a self-storage facility embodied to include an enhanced security self-storage door assembly 12 including a self-storage door frame 14 and a self-storage door 16. The self-storage door 16 is illustratively embodied as a retractable roll-up door, shown in a closed position to block access to the storage unit, and available for lifting (sliding) upward for retraction into an open position to permit access to the storage unit through the door frame 14. A door lock 18 is shown coupled with the self-storage door 16, embodied as a sliding latch (which may be manual or electronic), operable between a retracted position (shown) to allow movement of the self-storage door 16 out from the closed position to towards the open position, and an extended position to engage with the self-storage door frame 14 to block against movement of the self-storage door 16 out from the closed position. Referring to FIGS. 2A and 2B, the illustrative self-storage door 16 can be raised for opening by lifting, which causes rolling of the curtain panels onto a lift-assisted barrel 20 illustratively arranged on an interior of the self-storage door 16 which can be within the self-storage unit.

Self-storage door systems can provide protection against access to the self-storage unit, and can face unauthorized entry attempts. For example, unauthorized persons may attempt to tamper with doors and/or door hardware in attempt to gain unauthorized entry to the self-storage unit. Some brute force attacks can be unplanned and/or may lack sophistication, and may, for example, include a person attempting to forcibly open a locked self-storage door by hand or with minimal tools. Appropriately suited locks may avoid surrendering unauthorized access by resisting breakage and/or significant deformation, for example, to the latch. However, traditional self-storage door systems can reach their limits of design and/or tolerancing, and may, for example, be susceptible to such brute force attacks by exploiting tolerance thresholds of various components which may combine to allow unauthorized access under duress, such as deforming door assembly components enough such that the latch can no longer block against opening of the door even without breakage.

In one example, a traditional self-storage door may include a handle arranged center along the door width near its lower end that permits enough force to deform the self-storage door near the center of its width near the bottom edge. Such deformation may include permanent damage to the self-storage door (e.g., plastic bending, or buckling) permitting a small gap and/or may include dislodging the storage door from its connection with the door frame, for example, partly or wholly dislodging the door from a guide track of the frame permitting enough misalignment to create a gap in the doorway allowing authorized access.

Such deformation and/or misalignment vulnerabilities must be balanced against practicalities including the cost of self-storage door system design and/or installation. For example, designing more robust components which restrict deformation can be costly, while reducing tolerancing can increase design and/or installation costs, for example, by requiring tighter interface standards between the self-storage door and the self-storage door frame which can increase the difficulty of installation, increase wear, and/or require additional wear-reduction designs. Additionally, design and/or installation changes can increase the weight of the self-storage door and can cause additional burdens, such as increased requirements to hardware, such as self-storage door assist springs.

Referring to FIGS. 1-2B, the enhanced security self-storage door 16 illustratively includes a bottom bar assembly 22. The bottom bar assembly 22 can assist in providing enhanced security by resisting deformation and/or misalignment attacks as discussed in additional detail herein. The bottom bar assembly 22 is coupled with a curtain assembly 24 of the self-storage door 16. The curtain assembly 24 illustratively includes a number of curtain panels 26. The curtain panels 26 are illustratively embodied as corrugated panels which are coupled with each other in series along top and bottom edges to define a flexible door curtain which can be rolled onto the barrel when retracting the self-storage door 16.

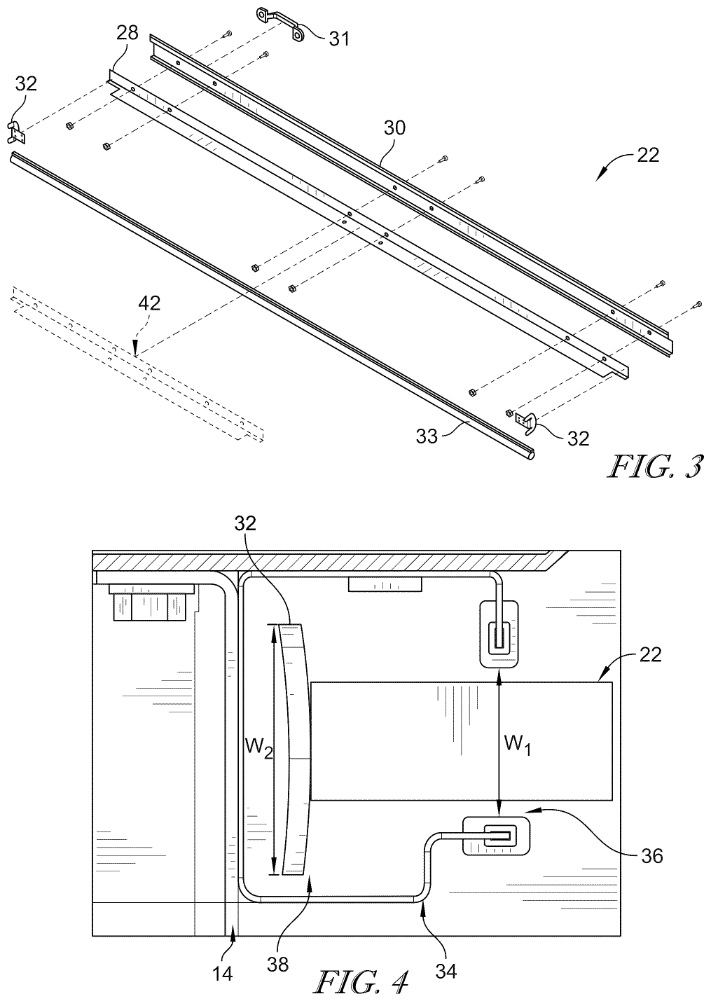

Referring to FIG. 3, the bottom bar assembly 22 is shown in exploded perspective view for ease of disclosure. The bottom bar assembly 22 includes a reinforcement strut 28 extending laterally between longitudinal ends of the assembly. The reinforcement strut 28 is illustratively embodied as a section of angle stock having an L-shape cross-sectional profile to provide rigidity to the bottom bar assembly 22. The reinforcement strut 28 is illustratively formed with thickness within a range of about 0.072 inches to about 0.097 inches. Such dimensions can provide adequate rigidity to block against brute force attacks without overdesign and/or needless cost. The reinforcement strut 28 is coupled with a bottom bar 30, illustratively by a number of bolt fasteners, a pair of which also illustratively couple a handle 31 with the bottom bar assembly 22 near one longitudinal end. The bottom bar 30 illustratively defines an externally facing portion of the bottom bar assembly 22 for coupling with the curtain assembly 24.

The bottom bar assembly 22 includes a number of guide retention clips 32 for blocking against movement of the self-storage door 16 out from engagement with the self-storage door frame 14. Referring to FIG. 4, the self-storage door 16 is shown engaged with the self-storage door frame 14 by receiving a lateral end of the self-storage door 16 (including the longitudinal end of the bottom bar assembly 22) within a guide assembly 34 of the self-storage door frame 14. The guide assembly 34 is embodied to include a guide track extending to define a vertical guide channel within which the guide retention clip 32 is shown for (vertical) sliding translation.

The guide assembly 34 illustratively includes a slot 36 allowing extension of the self-storage door 16 laterally into an interior 38 thereof, the opening 36 having narrower dimension w₁ than the interior 38 (along the vertical direction in the orientation as shown in FIG. 4). An optional set of wheels may assist in sliding the self-storage door 16 along the guide assembly 34. As the guide retention clip 32 extends with a dimension w₂ (along the vertical direction of FIG. 4) greater than the dimension w₁ of the opening 36, the guide retention clip 32 can avoid direct passage through the opening 36 to block against movement of the self-storage door out from engagement with the self-storage door frame 14. Additionally, within the tolerancing of the self-storage door assembly 12, articulation of the guide retention clip 32 by deformation of the bottom bar assembly 22 is limited to block against movement of the self-storage door out from engagement with the self-storage door frame 14 indirectly (e.g., twisting).

Returning to FIG. 3, the bottom bar assembly 22 illustratively includes a seal 33. The seal 33 is illustratively formed as a loop seal for coupling along the bottom surface of the bottom bar assembly 22 for engagement with the ground surface to form a resilient seal. In the illustrative embodiment, the seal 33 is coupled with the reinforcement strut 28 along the longitudinal width thereof.

Optionally, the bottom bar assembly can include an additional reinforcement strut 42 as shown in FIG. 3. The additional reinforcement strut 42 can be coupled, for example, by bolting, with the reinforcement strut 28 at the center of the longitudinal length of the reinforcement strut 28. In self-storage door applications of greater width, for example, exceeding 8 feet in width, the additional reinforcement strut 42 can add additional rigidity to the bottom bar assembly 22 as the ends of the bottom bar assembly 22 gain additional mechanical advantage relative to the center of the bottom bar assembly 22, while maintaining a standard bottom bar assembly 22 for most instances, avoiding more customization. In the illustrative embodiment, the additional reinforcement strut 42 is bolted on its vertical leg with the vertical leg of the reinforcement strut 28, and is clinch locked on its horizontal leg with the horizontal leg of the reinforcement strut 28.

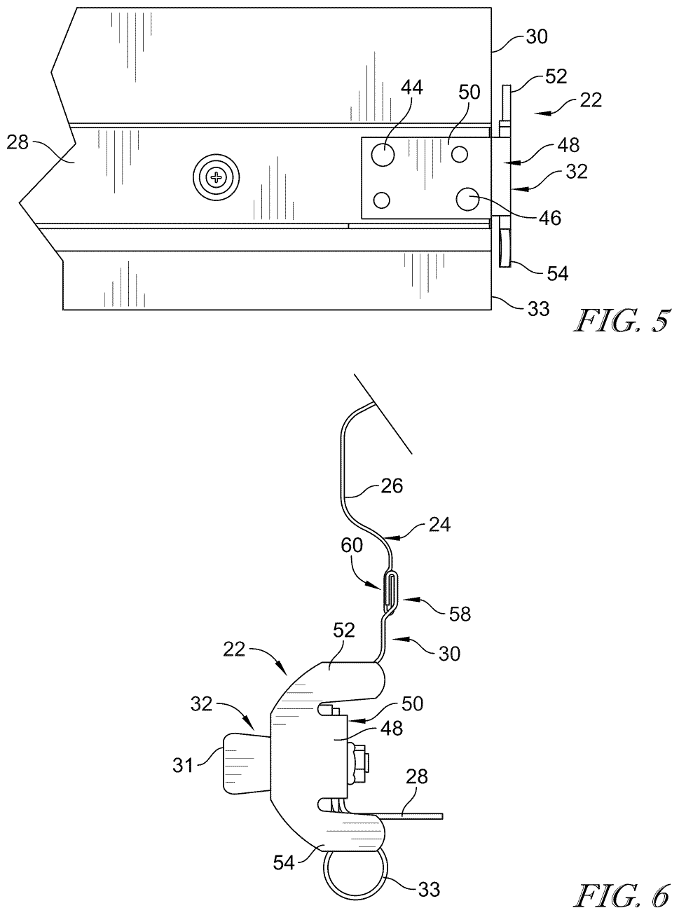

Referring to FIGS. 5 & 6, the guide retention clips 32 are illustratively coupled with the reinforcement strut 28 by clinch lock. As discussed in additional detail herein, clinch locking between the guide retention clips 32 and the reinforcement strut 28 establishes a number of clinch points 44, 46, and can provide ease, simplicity, low cost, and/or reliability of connection.

Each guide retention clip 32 illustratively includes a body 48 having an arm 50 extending from the body 48 generally perpendicularly for coupling with the reinforcement strut 28. Wings 52, 54 project from the body 48 (vertically and laterally in the orientation of FIG. 6) on opposite sides thereof. The wings 52, 54 provide dimensional reach of the guide retention clip 32 within the guide assembly 34 of the self-storage door frame.

Referring to FIG. 6, the bottom bar 30 is shown coupled with a lower one of the curtain panels 26 as a portion of the curtain assembly 24 of the self-storage door 16. The bottom bar 30 itself is illustratively embodied as similar in structure to the curtain panels. The bottom bar 30 includes a hooked terminal 58 defined on an upper end thereof formed complementary with a hooked terminal 60 of the curtain panel 26 on a lower end thereof. Together the hooked terminals 58, 60 can coupled together to form a seam.

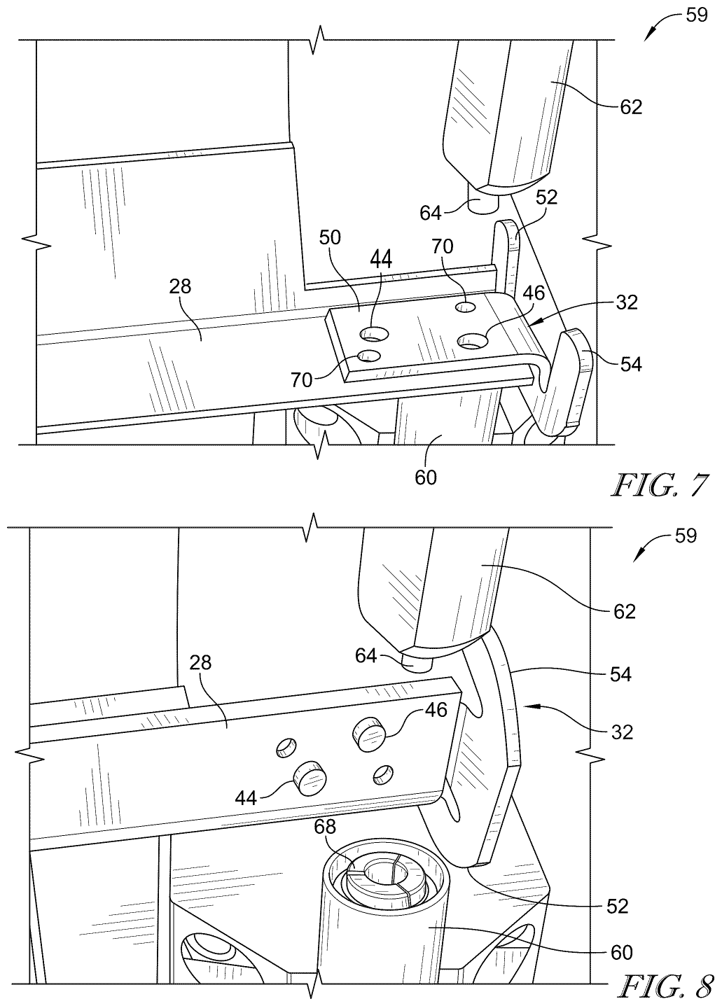

Referring now to FIGS. 7 & 8, a clinch locking process is illustrated. The arm 50 of the guide retention clip 32 is aligned with the end of the reinforcement strut 28. The aligned guide retention clip 32 and reinforcement strut 28 are positioned within the clinch press 59 between a lower seat 60 and upper drive 62 having a clinch tooth 64. The upper drive 62 engages to forcibly deliver the tooth 64 to drive clinching between the retention clip 32 and the reinforcement strut 28, illustratively include partially deformed a portion of the retention clip 32 through and into the reinforcement strut 28. An impression from each of the clinch points 44, 46 can be seen in FIG. 8.

A clinch seat 68 can be seen in FIG. 8 for receiving positioning of the aligned guide retention clip 32 and reinforcement strut 28 and for receiving at least a portion of the clinch tooth 64. Optional additional fastener holes 70 may be provided for coupling in other applications and/or embodiments. Accordingly, clinch locking can include partial deformation of the aligned guide retention clip 32 and reinforcement strut 28 together to form a fixed mechanical connection, without additional fasteners.

Returning briefly to FIG. 2B, optionally, guide retention clips 32 may be coupled with a latch panel of the curtain panels 26 of the curtain assembly 24 of the self-storage door 16 on which the lock 18 is installed. These guide retention clips 32 can be received within the guide assembly 34 just as discussed above to block against disengagement between the self-storage door 16 and the self-storage door frame 14 near the lock itself. These guide retention clips 32 can provide additional blocking against brute force attacks which make seek to drive force into the door near the center of the curtain assembly 24.

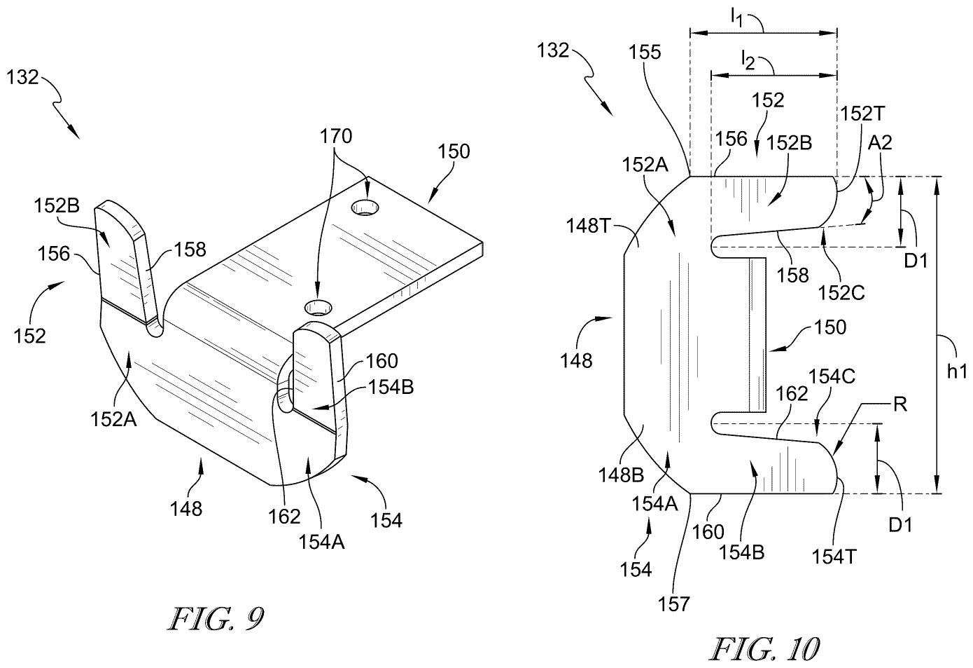

Another embodiment of a guide retention clip 132 for use in the bottom bar assembly 22 and the self-storage door assembly 12 is shown in FIGS. 9-12. As mentioned in additional detail herein, the guide retention clip 132 is defined to have narrowed vertical extent to assist in facilitating a different variety of latches in self-storage applications. The guide retention clip 132 is substantially similar to the guide retention clip 32 shown in FIGS. 1-8 and described herein, and the disclosure of the guide retention clip 32 applies equally to the guide retention clip 132, except in instances of conflict with the specific disclosure of the guide retention clip 132. Similar reference numbers in the 100 series indicate features that are common between the guide retention clip 132 and the guide retention clip 32.

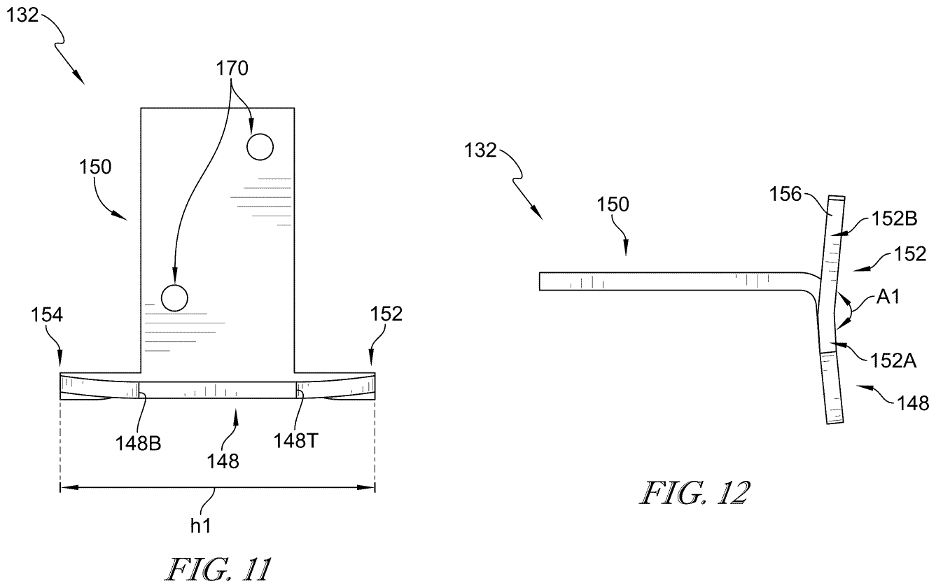

The guide retention clip 132 includes a body 148 and an arm 150 extending from the body 148 generally perpendicularly away therefrom, as shown in FIG. 9. The arm 150 is configured to be coupled with the reinforcement strut 28. While the arm 150 is coupled with the reinforcement strut 28 in the installed position, the arm 150 extends generally horizontally along the vertical plane. The arm 150 is formed to include at least one fastener hole 170 extending therethrough, as shown in FIGS. 9 and 11. In the illustrative embodiment, the arm 150 is formed to include two fastener holes 170 extending therethrough. In some embodiments, the arm 150 may be formed to include fewer holes or greater holes. In some embodiments, the arm 150 is additionally or alternatively coupled with the reinforcement strut 28 by clinch lock, as described above.

The guide retention clip 132 further includes wings 152, 154 that project from opposing sides of the body 148, as shown in FIG. 10. The wing 152 extends vertically and laterally from a topside 148T of the body 148 (based on the orientation of FIG. 10). The wing 154 extends vertically and laterally from a bottomside 148B of the body 148 opposite the topside 148T (based on the orientation of FIG. 10). The wings 152, 154 each provide dimensional reach of the guide retention clip 132 within the guide assembly 34 of the self-storage door frame 14. In the illustrative embodiment, the guide retention clip 132 is integrally formed as a single, one-piece component.

As shown in FIG. 10, each wing 152, 154 includes a connection portion 152A, 154A coupled with the body 148 and a projection portion 152B, 154B extending laterally away from the corresponding connection portion 152A, 154A. The projection portion 152B, 154B is coupled with the corresponding connection portion 152A, 154A and spaced apart from the body 148. The connection portions 152A, 154A and the body 148 are located substantially in the same plane, as shown in FIG. 12. Each of the projection portions 152B, 154B extends outwardly away from the corresponding connection portion 152A, 154A and from the arm 150, as shown in FIG. 12. In other words, the projection portions 152B, 154B are angled relative to the corresponding connection portion 152A, 152A to form an angle A1 therebetween. In this way, the projection portions 152B, 154B are located in a slightly different plane than the connection portions 152A, 154A. In some embodiments, the angle A1 is about 165 degrees to about 175 degrees. In the illustrative embodiment, the angle A1 is about 170 degrees.

As shown in FIG. 10, the projection portion 152B, 154B of each of the wings 152, 154 tapers as the projection portion 152B, 154B extends away from the corresponding connection portion 152A, 152A. The projection portion 152B, 154B of each of the wings 152, 154 has a vertical height that is narrower than in traditional guide retention clips. In other words, each of the wings 152, 154 defines a narrowed extent of their respective portion, such that the wings 152, 154 collectively define a slim vertical profile of the guide retention clip 132 compared with the guide retention clip 32. For example, each of the projection portions 152B, 154B of the wings 152, 154 may have a vertical height (based on the orientation of FIG. 10) that is about 0.125 inches less than in traditional guide retention clips.

The projection portion 152B extends between a top surface 156 and a bottom surface 158 (based on the orientation of FIG. 10). A terminal (maximum) point 152T defined on an end 152C of the projection portion 152B is located closer to the top surface 156 of the projection portion 152B than the bottom surface 158 of the projection portion 152B, as shown in FIG. 10. The projection portion 154B extends between a top surface 162 and a bottom surface 160 (based on the orientation of FIG. 10). A terminal (maximum) point 154T defined on an end 154C of the projection portion 154B is located closer to the bottom surface 160 of the projection portion 154B than the top surface 162 of the projection portion 154B, as shown in FIG. 10.

A distance D1 is formed between the top surface 156 of the projection portion 152B and a center point between the bottom surface 158 of the projection portion 152B and the body 148, as shown in FIG. 10. The distance D1 is also formed between the bottom surface 160 of the projection portion 154B and a center point between the top surface 162 of the projection portion 154B and the body 148. In some embodiments, the distance D1 is about 0.5 inches to about 0.55 inches. In the illustrative embodiment, the distance D1 is about 0.514 inches.

The guide retention clip 132 has a height h₁ as defined between the top surface 156 of the projection portion 152B and the bottom surface 160 of the projection portion 154B, as shown in FIGS. 10 and 11. In some embodiments, the height h₁ is about 2.2 inches to about 2.4 inches. In the illustrative embodiment, the height h₁ is about 2.315 inches. The height h₁ is at least 0.25 inches less than in traditional guide retention clips. Accordingly, the guide retention clip 132 illustratively defines a narrowed vertical profile relative to traditional guide retention clips.

A length 11 is defined between the terminal point 152T and an end 155 of the top surface 156 farthest away from the terminal point 152T, as shown in FIG. 10. In some embodiments, the length 11 is about 1 inch to about 1.1 inches. In the illustrative embodiment, the length 11 is about 1.071 inches. The length 11 is also defined between the terminal point 154T and an end 157 of the bottom surface 160 farthest away from the terminal point 154T.

A length 12 is defined between the terminal point 152T and the connection portion 152A, as shown in FIG. 10. In some embodiments, the length 12 is about 0.9 inches to about 1 inch. In the illustrative embodiment, the length 12 is about 0.92 inches. The length 12 is also defined between the terminal point 154T and the connection portion 154A.

The top surface 156 of the projection portion 152B and the bottom surface 158 of the projection portion 152B form an angle A2 therebetween, as shown in FIG. 10. In some embodiments, the angle A2 is of about 3 degrees to about 7 degrees. In the illustrative embodiment, is angle A2 is about 5 degrees. The bottom surface 160 of the projection portion 154B and the top surface 162 of the projection portion 154B also form the angle A2 therebetween.

Each of the ends 152C, 154C of the projection portions 152B, 152B has a radius of curvature R. In some embodiments, the radius of curvature R is about 0.2 inches to about 0.4 inches. In the illustrative embodiment, the radius of curvature is about 0.3 inches.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

We claim:

1. A self-storage door assembly, comprising:
a self-storage door frame defining a doorway, the self-storage door frame including a guide assembly including at least one track extending vertically; and
a self-storage door for engagement with the self-storage door frame for movement along the guide assembly between a closed position blocking against access through the door way and an open position allowing access through the door way, the self-storage door comprising:
a curtain assembly including a number of panels; and
a bottom bar assembly coupled with the curtain assembly near a lower end thereof, the bottom bar assembly comprising a reinforcement strut coupled with the curtain assembly to block against deflection of the self-storage door, and at least one guide retention clip coupled with the reinforcement strut and received within the track of the guide assembly to block against movement of the self-storage door out from engagement with the self-storage door frame.

2. The self-storage door assembly of claim 1, wherein the at least one guide retention clip and the reinforcement strut are fastened together by clinch lock.

3. The self-storage door assembly of claim 2, wherein the clinch lock omits a separate fastener.

4. The self-storage door assembly of claim 2, wherein the clinch lock includes deformation of the material of one of the at least one guide retention clip and the reinforcement strut into the other.

5. The self-storage door assembly of claim 1, wherein the reinforcement strut comprises a rigid stock formed with L-shaped cross-sectional profile.

6. The self-storage door assembly of claim 1, wherein the reinforcement strut extends along an entire width of the curtain assembly.

7. The self-storage door assembly of claim 6, wherein the reinforcement strut extends along an entire width of the curtain assembly exceeding 8 feet, and the bottom bar assembly comprising an additional reinforcement strut coupled with the reinforcement strut, wherein the additional reinforcement strut extends only partially along the width of the curtain assembly.

8. The self-storage door assembly of claim 7, wherein the additional reinforcement strut is positioned near the center of the reinforcement strut.

9. The self-storage door assembly of claim 1, wherein the reinforcement strut has a thickness within the range of about 0.072 and about 0.097 inches.

10. The self-storage door assembly of claim 1, wherein the reinforcement strut has a thickness no greater than about 0.097 inches.

11. The self-storage door assembly of claim 1, wherein the curtain assembly including a latch panel of the number of panels, the latch panel having one of a latch and latch receiver coupled thereto for engagement with the other of the latch receiver and latch coupled with the self-storage door frame to allow selective engagement of the latch with the latch receiver to block against movement of the self-storage door relative to the self-storage frame between the open and closed positions, wherein the latch panel includes at least one guide retention clip coupled thereto and received within the track of the guide assembly.

12. The self-storage door assembly of claim 11, wherein no other panel of the number of panels includes any guide retention clip.

13. The self-storage door assembly of claim 1, further comprising a handle coupled with the self-storage door off-center.

14. The self-storage door assembly of claim 1, wherein the handle is coupled with the self-storage door near a lateral side thereof.

15. A self-storage door for engagement with a guide assembly of a door frame for movement between a closed position blocking against access through a doorway and an open position allowing access through the doorway, the self-storage door comprising:
a curtain assembly including a number of panels; and
a bottom bar assembly coupled with the curtain assembly near a lower end thereof, the bottom bar assembly comprising a reinforcement strut coupled with the curtain assembly to block against deflection of the self-storage door, and at least one guide retention clip coupled with the reinforcement strut and received within a track of the guide assembly to block against movement of the self-storage door out from engagement with the self-storage door frame.

16. The self-storage door of claim 15, wherein the at least one guide retention clip and the reinforcement strut are fastened together by clinch lock.

17. The self-storage door of claim 16, wherein the clinch lock includes deformation of the material of one of the at least one guide retention clip and the reinforcement strut into the other.

18. The self-storage door of claim 15, wherein the reinforcement strut comprises a rigid stock formed with L-shaped cross-sectional profile.

19. A method of assembling a self-storage door, the method comprising:
coupling a reinforcement strut with a curtain assembly as a part of a bottom bar assembly; and
coupling at least one guide retention clip with the bottom bar assembly for reception within a track of a guide assembly.

20. The method of claim 19, wherein coupling the at least one guide retention clip with the bottom bar assembly includes clinch locking the at least one guide retention clip with a reinforcement strut of the bottom bar assembly.
